(19) United States
(12) Patent Application Publication
(10) Pub. No.: US 2024/0418287 A1
(43) Pub. Date: Dec. 19, 2024

(54) A Linear Motor For Use In A Molten Salt Nuclear Reactor And A Valve For Use In A Molten Salt Nuclear Reactor

(71) Applicant: Copenhagen Atomics A/S, Kastrup (DK)

(72) Inventors: Aslak STUBSGAARD, Copenhagen K (DK); Thomas Jam PEDERSEN, Copenhagen K (DK); Thomas STEENBERG, Copenhagen K (DK)

(73) Assignee: Copenhagen Atomics A/S, Kastrup (DK)

(21) Appl. No.: 18/730,117

(22) PCT Filed: Jan. 25, 2023
(86) PCT No.: PCT/DK2023/050012

§ 371 Date: Jul. 18, 2024

(30) Foreign Application Priority Data
Feb. 1, 2022 (DK) PA202270042

(51) Int. Cl. F16K 31/04; G21C 7/14; H02K 41/025; H02K 41/03

(52) U.S. Cl. CPC F16K 31/04; G21C 7/14; H02K 41/025; H02K 41/03

(57) ABSTRACT

A tubular linear motor (20), for operating actuating a component in a molten salt loop (43,44,45), preferably a molten salt loop (43,44,45) in a nuclear reactor (40), comprising a stator (11) having a lumen, a tubular translational mover (8) in the lumen, the stator (11) comprising stator windings surrounding the lumen for inducing a magnetic field penetrating the mover (8), the stator windings each comprising an electrically conductive solid bar (12), at least a portion of the length thereof being arranged spirally, the spirally arranged portion being arranged between first- and second ferromagnetic rings (26,27), the spirally arranged portion of the length of electrically conductive solid bar (12) being positioned between the first- and second ferromagnetic rings (26,27), by one or more spacers (13), preferably ceramic spacers (13), for electrically insulating the electrically conductive solid bar (12) from the first- and second ferromagnetic rings (26,27).

### TECHNICAL FIELD

The disclosure relates to linear motors for use in a molten salt nuclear reactor, e.g. for actuating a valve or control rod, and to a valve for operating with a working fluid such as molten salt, a cover gas, or other high temperature fluid of a molten salt nuclear reactor.

### BACKGROUND

A molten salt reactor (MSR) is a nuclear reactor where the nuclear reactor coolant and/or the nuclear fuel is a molten salt, typically a fluoride or chloride salt, with a melting point of around ˜500° C., operating temperature of around ˜600 to 700° C., and a boiling point of ˜1000° C. above the melting point. One of the many advantages of this type of reactor is that molten salts including the fuel can be used as the heat transfer media at very high temperatures while still operating at or close to atmospheric pressure. Heat is extracted from such reactors by pumping the molten salt in a loop between the ‘core’ and a heat exchanger with the reactor power being directly proportional to the temperature drop across the heat exchanger and the flow rate. To maintain a molten salt reactor during normal operation and in emergencies, controlling the molten salt flow rate and path is essential, often achieved through valves. e.g. by throttling the flow, diverting the path, or draining the salt to a ‘dump’ tank to bring the fuel salt sub-critical and remove decay heat. Valves are also needed for transfer lines for loading and or removing the salt from the reactor and for isolation of instrument lines going to the reactor. Another essential device often used for maintaining the core criticality during normal operation or shutdown are control rods, which absorb neutrons and thereby regulate the neutron chain reaction. Both of these essential devices require reliable and remote operation in a molten salt reactor and often rely on precise linear actuation and if exposed to the flowing molten salt a high requirement on leak tightness is imposed. Often, the operation of such components is achieved by having a separating barrier in the form of a diaphragm, in the case of a valve, or isolating the component inside a tube or thimble, in the case of a control rod, and placing the linear motor outside the high temperature region with radiation shielding so that standard components can be used. The disadvantage of this approach is that the arrangement becomes large and complicated due to the large separation distance needed for thermal insulation and radiation shielding and the large temperature gradient resulting in large differential thermal expansions. The complexity of which can lead to failures such as jamming or shearing. Furthermore, separation barriers, such as bellows have a much higher chance of failure compared to static components, due to being flexed and deformed by each actuation, with the potential consequence of failure being salt leakage out of the system.

Thus, a reliable linear motor and valve are desired, capable of operating inside the high temperature and high irradiation environment of a molten salt reactor, with no deforming components such as bellows or dynamic seals such as a stuffing box around a shaft.

US2010/0243931 discloses a valve suitable for handling low to medium temperature working fluids, having a valve body having spaced inlet and outlet ports separated by an intermediate valve seat in open communication with the inlet and outlet ports includes a piston and a valve member being adapted to sealingly mate with the valve seat. A biasing member is positioned to bias the valve member toward the valve seat. A linear motor assembly attached to the valve body, the linear motor having a plurality of stator discs, a plurality of stator coils, a plurality of teeth defining a cylindrical opening, and a slider positioned within the cylindrical opening. The slider has a plurality of teeth defining a generally cylindrical outer periphery of the slider and is movable in response to magnetic flux generated by electrical current passing through one or more of the stator coils.

US2017301413 discloses a molten salt nuclear reactor with a salt loop comprising a valve, as well as nuclear fuel salts usable in certain molten salt reactor designs and related systems and methods. Binary, ternary, and quaternary chloride fuel salts of uranium, as well as other fissionable elements, are described. In addition, fuel salts of UC1₄ are disclosed as well as bromide fuel salts. This disclosure also presents methods and systems for manufacturing such fuel salts, for creating salts that reduce corrosion of the reactor components, and for creating fuel salts that are not suitable for weapons applications.

### SUMMARY

It is an object to provide a linear motor that overcomes or at least reduces one or more of the problems described above. The foregoing and other objects are achieved by the features of the independent claims. Further implementation forms are apparent from the dependent claims, the description, and the figures.

According to a first aspect, there is provided a tubular linear motor, preferably a switched reluctance or AC induction linear motor, for actuating a component in a molten salt loop, preferably a molten salt loop in a nuclear reactor, the tubular linear motor comprising:
a stator having a lumen,
a tubular translational mover at least partially received inside the lumen,
the stator comprising at least two stator windings, each stator winding surrounding the lumen and a portion of the mover that is received inside the lumen for inducing a magnetic field that penetrates the mover,
the at least two stator windings each comprising an electrically conductive solid bar, preferably a copper bar, at least a portion of the length of the electrically conductive solid bar being arranged spirally,
first- and second ferromagnetic rings,
one or more spacers, preferably ceramic spacers,
   at least the spirally arranged portion of the length of electrically conductive solid bar being arranged between the first- and second ferromagnetic rings, said first- and second ferromagnetic rings preferably being iron or cobalt alloy rings,
the spirally arranged portion of the length of the electrically conductive solid bar being positioned between the first- and second ferromagnetic rings by the one or more spacers for electrically insulating the electrically conductive solid bar from the first- and second ferromagnetic rings.

Thus, a compact linear motor that can be placed in the high temperature and high irradiation environment of a molten salt reactor is provided, which can operate without the use of dynamic seals or flexible membranes or bellows. The high temperature canned electromagnetic linear motor can therefore be directly coupled to the actuated components such as a valve or control rod. This is achieved through the separating function of the can, and the use of solid copper bars electrically insulated from the stator and can by ceramic spacers. Thus, allowing for electrical insulation in the high temperature and high irradiation environment while being mechanically reliable. Besides the mover that is held in place by bearings, there are no moving parts.

According to a possible implementation form of the first aspect, the mover has a plurality of circumferential projections, preferably regularly spaced projections.

According to a possible implementation form of the first aspect, the stator windings are spaced to match the spacing between the projections, the spacing between the stator windings, and the projections preferably being a regular spacing.

According to a possible implementation form of the first aspect, the tubular linear motor comprises a non-magnetic ring placed between a neighboring first- and second ferromagnetic ring of two consecutive stator windings.

According to a possible implementation form of the first aspect, the stator windings together with the first- and second ferromagnetic rings are arranged in a stack, preferably with a nonmagnetic ring separating neighboring first- and second ferromagnetic ring of two consecutive stator windings in the stack.

According to a possible implementation form of the first aspect, the electrically conductive solid bar has a uniform cross-section throughout the spirally arranged portion of the length electrically conductive solid bar.

According to a possible implementation form of the first aspect, one or more spacers are provided between the spirally arranged portion of the length of an electrically conductive solid bar and the first ferromagnetic ring and the spirally arranged portion of the length of the electrically conductive solid bar one or more spacers are provided between the spirally arranged portion of the length of the electrically conductive solid bar concerned and the second ferromagnetic ring.

According to a possible implementation form of the first aspect, the second ferromagnetic ring is provided with an annular recess in which at least a portion of the spirally arranged portion of the length of the electrically conductive solid bar is received.

According to a possible implementation form of the first aspect, the first- and/or second ferromagnetic rings are provided with one or more spacer recesses for receiving and securing at least a portion of the spacers, the space recesses preferably forming a radial groove in the respective ferromagnetic ring.

According to a possible implementation form of the first aspect, the first- and/or second ferromagnetic rings are provided with a plurality of circumferentially spaced spacer recesses.

According to a possible implementation form of the first aspect, the stator winding comprises a spirally arranged electrically conductive bar, preferably with a uniform cross-section throughout its length, electrically coupled to a radially extending straight electrically conductive bar, that preferably protrudes radially from the stator to form an electric terminal.

According to a possible implementation form of the first aspect, wherein the stator winding comprises an electrically conductive bar that comprises a spirally arranged section and a radially arranged section, the radially arranged section preferably extending radially from the stator to form an electric terminal.

According to a possible implementation form of the first aspect, the linear actuator comprises a controller configured to control current through the respective windings (12), preferably current delivered by power amplifiers, for controlling the position and movement of the mover.

According to a possible implementation form of the first aspect, the spacers are electrically insulating or have low electric conductivity, the spacers preferably being ceramic spacers.

According to a possible implementation form of the first aspect, wherein the spacers are configured to space the solid bar from surfaces of the first- and second ferromagnetic rings, and/or configured to space turns of the spirally arranged portion of the length of the electrically conductive solid bar from one another.

According to a possible implementation form of the first aspect, the spacers are formed by refractory cement, the refractory cement preferably having been applied after positioning the solid bars in the slots.

According to a possible implementation form of the first aspect, the spacers support the solid bar locally and wherein the spacers are provided at two or more circumferential spaced positions along the circumference of the spirally arranged portion of the length of an electrically conductive solid bar.

According to a possible implementation form of the first aspect, the solid bars are positioned between the first- and second ferromagnetic rings by being embedded in an electrically insulating material, the insulating material preferably being refractory cement.

According to a possible implementation form of the first aspect, the solid bars have a cross-sectional area of at least 16 mm2, preferably at least 13 mm2, more preferably at least 10 mm2, even more preferably at least 7 mm2, most preferably at least 5 mm2.

According to a possible implementation form of the first aspect, the solid bars are sufficiently rigid to maintain their shape under influence of magnetic forces generated when the linear motor is operating, without coming in contact with surfaces of the first- and second ferromagnetic rings in which they are received, and without the turns of the spirally arranged section of the electrically conductive solid bar coming in contact with one another, with the solid bars being supported in the slot by the spacers only.

According to a possible implementation form of the first aspect, the electrically conductive solid bars have a substantially rectangular cross-sectional outline, preferably a substantially squared cross-sectional outline, the corners of the rectangular or squared cross-sectional outline preferably being rounded.

According to a possible implementation form of the first aspect, the stator windings are coupled to one or more controllable power amplifiers for independently energizing the stator windings.

According to a possible implementation form of the first aspect, the mover is supported by linear slide bearings.

According to a possible implementation form of the first aspect, the mover is supported by radial electromagnetic bearings.

According to a second aspect there is provided a valve constructed to operate at a temperature above 450° C., and suitable for operating with a high-temperature working fluid such as molten salt, a cover gas, or other high temperature fluid, e.g. of a molten salt nuclear reactor, the valve comprising: a valve body comprising: an inlet, an outlet, and a valve seat or valve sleeve arranged between the inlet and the outlet, a linearly movable tubular valve member configured to cooperate with the valve seat valve sleeve to allow the linear movable tubular valve member to assume a position where the valve is closed and one or more positions where the valve is open, a tubular linear motor comprising: a stator having a lumen, a tubular translational mover at least partially received inside the lumen, being coupled to the linearly movable tubular valve member move in unison therewith, the mover having a plurality of circumferential projections, the stator comprising at least two stator windings surrounding the lumen and a portion of the mover that is received inside the lumen for inducing a magnetic field that penetrates the mover, a containment shell, separating a working fluid area, from a dry area containing the stator, with the mover arranged in the working fluid area.

According to a possible implementation form of the second aspect, the tubular linear motor is a switched reluctance motor or an AC induction motor.

According to a possible implementation form of the second aspect, the tubular linear motor is directly attached to the valve body or is arranged inside the valve body.

According to a possible implementation form of the second aspect, a clearance is arranged between the mover and the can, the valve 1 preferably being configured for allowing a flow of working fluid through the clearance for cooling the valve.

According to a possible implementation form of the second aspect, wherein the stator windings are spaced to match the spacing between the projections, the spacing between the stator windings and the projections preferably being a regular spacing.

According to a possible implementation form of the second aspect, a non-magnetic ring is placed between a neighboring first- and second ferromagnetic ring of two consecutive stator windings.

According to a possible implementation form of the second aspect, the stator windings together with the first- and second ferromagnetic rings are arranged in a stack, preferably with a nonmagnetic ring separating neighboring first- and second ferromagnetic rings of two consecutive stator windings in the stack.

According to a possible implementation form of the second aspect, the mover is a tubular element that is mounted on the tubular valve member, the hollow shaft having a lumen, the lumen in the valve member preferably being fluidically connected to the clearance and allowing a flow of working fluid from the inlet through the lumen and the clearance to the outlet.

According to a possible implementation form of the second aspect, the lumen is in direct and permanent fluid connection with the inlet.

According to a possible implementation form of the second aspect, the valve comprises at least two stator windings each comprising an electrically conductive solid bar, preferably a copper bar, at least a portion of the length of the electrically conductive solid bar being arranged spirally, at least the spirally arranged portion of the length of electrically conductive solid bar being arranged between first- and second ferromagnetic rings, the first- and second ferromagnetic rings preferably being iron or cobalt alloy rings.

According to a possible implementation form of the second aspect, the spirally arranged portion of the length of the electrically conductive solid bar is positioned between the first- and second ferromagnetic rings by one or more spacers, preferably ceramic spacers, for electrically insulating the electrically conductive solid bar from the first- and second ferromagnetic rings.

According to a possible implementation form of the second aspect, the electrically conductive solid bar has a uniform cross-section throughout the spirally arranged portion of the length electrically conductive solid bar.

According to a possible implementation form of the second aspect, one or more spacers are provided between the spirally arranged portion of the length of an electrically conductive solid bar and the first ferromagnetic ring and the spirally arranged portion of the length of the electrically conductive solid bar one or more spacers are provided between the spirally arranged portion of the length of the electrically conductive solid bar concerned and the second ferromagnetic ring.

According to a possible implementation form of the second aspect, the second ferromagnetic ring is provided with an annular recess in which at least a portion of the spirally arranged portion of the length of the electrically conductive solid bar is received.

According to a possible implementation form of the second aspect, the first- and/or second ferromagnetic rings are provided with one or more spacer recesses for receiving and securing at least a portion of the spacers, the space recesses preferably forming a radial groove in the respective ferromagnetic ring.

According to a possible implementation form of the second aspect, the first- and/or second ferromagnetic rings are provided with a plurality of circumferentially spaced spacer recesses.

According to a possible implementation form of the second aspect, the stator winding comprises a spirally arranged electrically conductive bar, preferably with a uniform cross-section throughout its length, electrically coupled to a radially extending straight electrically conductive bar, that preferably protrudes radially from the stator to form an electric terminal.

According to a possible implementation form of the second aspect, the stator winding comprises an electrically conductive bar that comprises a spirally arranged section and a radially arranged section, the radially arranged section preferably extending radially from the stator to form an electric terminal.

According to a possible implementation form of the second aspect, the valve comprises a controller configured to control current through the respective windings, preferably current delivered by power amplifiers, for controlling the position and movement of the mover.

The valve according to any one of the preceding claims, wherein the spacers are electrically insulating or have low electric conductivity, the spacers preferably being ceramic spacers.

According to a possible implementation form of the second aspect, the spacers are configured to space the solid bar from surfaces of the first- and second ferromagnetic rings, and/or configured to space turns of the spirally arranged portion of the length of the electrically conductive solid bar from one another.

According to a possible implementation form of the second aspect, the spacers are formed by refractory cement, the refractory cement preferably having been applied after positioning the solid bars in the slots.

According to a possible implementation form of the second aspect, the spacers support the solid bar locally and wherein the spacers are provided at two or more circumferential spaced positions along the circumference of the spirally arranged portion of the length of the electrically conductive solid bar.

According to a possible implementation form of the second aspect, the solid bars are positioned between the first- and second ferromagnetic rings by being embedded in an electrically insulating material, the insulating material preferably being refractory cement.

According to a possible implementation form of the second aspect, the solid bars have a cross-sectional area of at least 16 mm2, preferably at least 13 mm2, more preferably at least 10 mm2, even more preferably at least 7 mm2, most preferably at least 5 mm2.

According to a possible implementation form of the second aspect, the solid bars are sufficiently rigid to maintain their shape under influence of magnetic forces generated when the linear motor is operating, without coming in contact with surfaces of the first- and second ferromagnetic rings in which they are received, and without the turns of the spirally arranged section of the electrically conductive solid bar coming in contact with one another, with the solid bars being supported in the slot by the spacers only.

According to a possible implementation form of the second aspect, the electrically conductive solid bars have a substantially rectangular cross-sectional outline, preferably a substantially squared cross-sectional outline, the corners of the rectangular or squared cross-sectional outline preferably being rounded.

According to a possible implementation form of the second aspect, the stator windings are coupled to one or more controllable power amplifiers for independently energizing the stator windings.

According to a possible implementation form of the second aspect, the mover is supported by linear slide bearings.

According to a possible implementation form of the second aspect, the mover is supported by active magnetic bearings.

According to the third aspect, there is provided a molten salt loop, preferably of a molten salt nuclear reactor, the molten salt loop comprising a valve suitable for handling a flow of molten salt, the valve comprising: a valve body comprising: an inlet, an outlet, and a valve seat or valve sleeve arranged between the inlet and the outlet, a linearly movable tubular valve member configured to cooperate with the valve seat or valve sleeve to allow the linear movable tubular valve member to assume a position where the valve is closed and one or more positions where the valve is open, a tubular linear motor comprising: a stator having a lumen,
a tubular translational mover at least partially received inside the lumen, the tubular translational mover being coupled to the linearly movable tubular valve member move in unison therewith, the tubular translational mover having a plurality of circumferential projections, the stator comprising at least two stator windings surrounding the lumen and a portion of the mover that is received inside the lumen for inducing a magnetic field that penetrates the mover, a containment shell, separating a working fluid area, from a dry area containing the stator, with the mover arranged in the working fluid area.

According to a fourth aspect is provided a use of a valve in a molten salt loop preferably in a molten salt loop of a molten salt nuclear reactor, said valve comprising:
a valve body comprising:
   an inlet,
   an outlet, and
   a valve seat or valve sleeve arranged between the inlet and the outlet,
a linearly movable tubular valve member configured to cooperate with the valve seat or valve sleeve to allow the linear movable tubular valve member to assume a position where the valve is closed and one or more positions where the valve is open,
a tubular linear motor comprising:
a stator having a lumen,
a tubular translational mover at least partially received inside the lumen, being coupled to the linearly movable tubular valve member move in unison therewith,
   the stator comprising at least two stator windings surrounding the lumen and a portion of the mover that is received inside the lumen for inducing a magnetic field that penetrates the mover, and
   a containment shell, separating a working fluid area, from a dry area containing the stator, with the mover arranged in the working fluid area.

These and other aspects will be apparent from the embodiments described below.

### BRIEF DESCRIPTION OF THE DRAWINGS

In the following detailed portion of the present disclosure, the aspects, embodiments, and implementations will be explained in more detail with reference to the example embodiments shown in the drawings, in which:

FIG. 1 is an elevated view of a linear motor in accordance with an embodiment coupled to a valve in accordance with an embodiment;

FIG. 2 is a sectional view of the linear motor and valve illustrated in FIG. 1, with the valve in an open position;

FIG. 3 is another sectional view of the linear motor and valve illustrated in FIG. 1, with the valve in a closed position;

FIG. 4 is a side view of a stack of coils of the motor in accordance with FIG. 1;

FIG. 5 is a cross-sectional view of the stack of coils of FIG. 4;

FIG. 6 is an elevated view of the stack of coils of FIG. 4;

FIG. 7 is an exploded view of a coil of the stack of FIG. 4;

FIG. 8 is a diagrammatic representation of an embodiment of the valve and motor in situ in a molten salt loop in a nuclear Reactor,

FIGS. 9 to 11 illustrate another embodiment of the linear motor coupled to a different type of valve,

FIGS. 12 and 13 illustrate another embodiment of the linear motor with active electromagnetic bearings,

FIGS. 14 to 17 illustrate an embodiment of a control rod operably coupled to a linear motor according to an embodiment, and

FIGS. 18, 18a, 19 to 20 illustrate an embodiment of a control rod operably coupled to a linear motor according to an embodiment.

### DETAILED DESCRIPTION

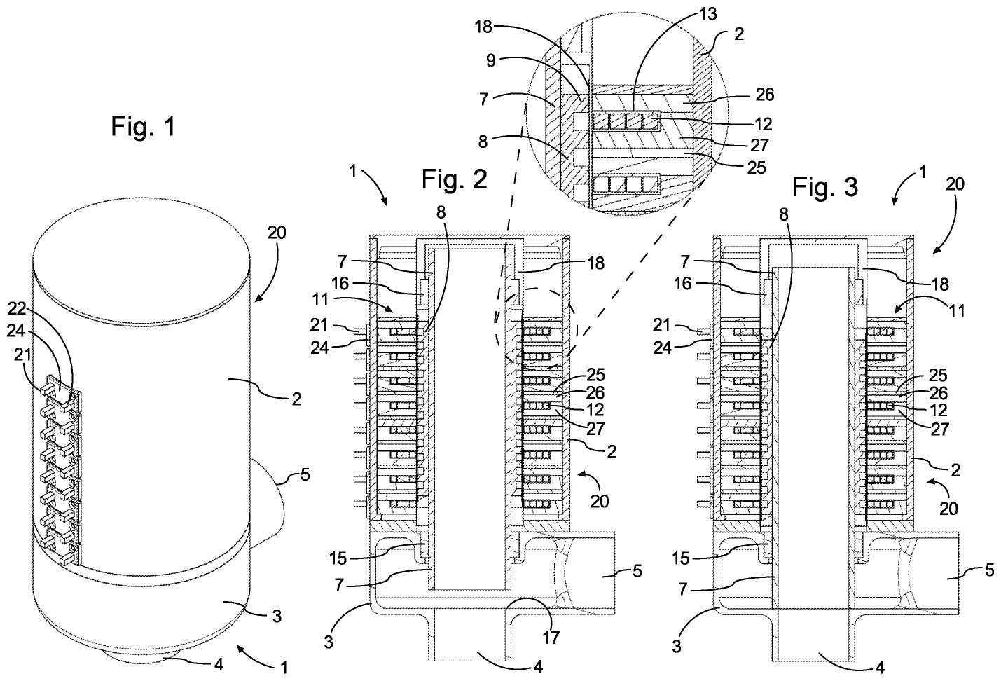

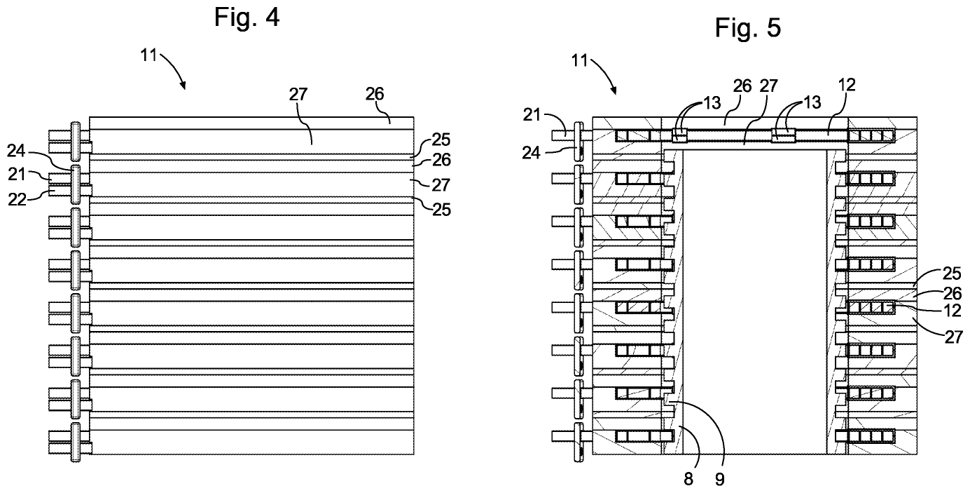

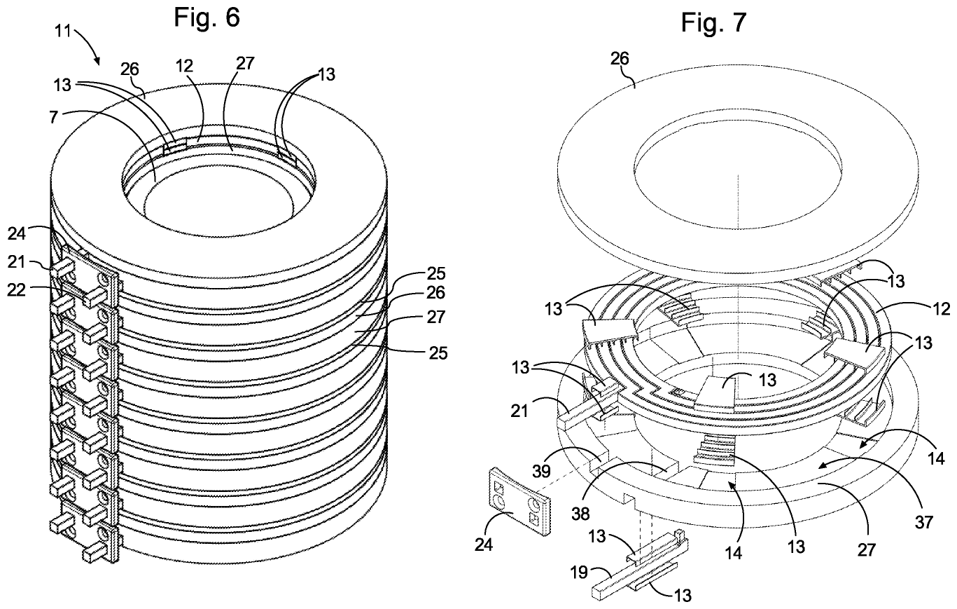

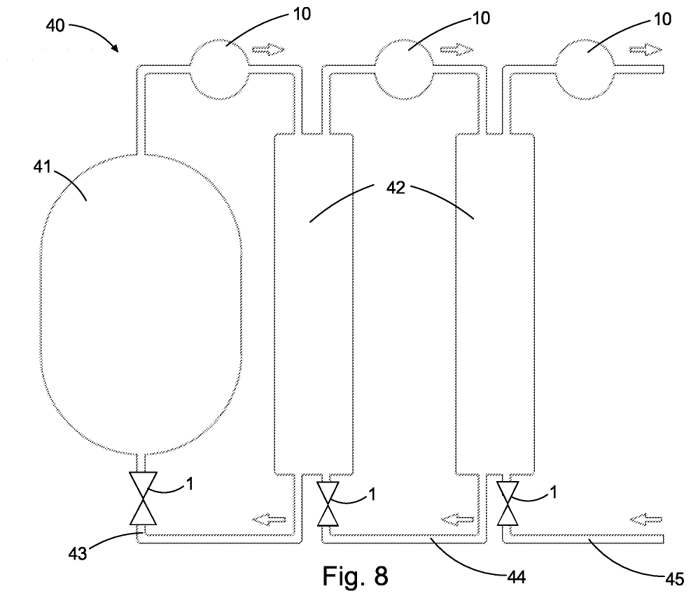

An embodiment of a linear motor 20 and of a valve 1 that can be actuated with the linear motor 20 is illustrated with reference to FIGS. 1 to 8. A molten salt nuclear reactor comprising the valve 1 is illustrated with reference to FIG. 8.

In the following description, the valve 1 is described with reference to an embodiment in which the valve 1 is actuated by a linear motor 20. However, it is understood that in another embodiment the valve 1 can be activated by another type of motor, e.g. a rotary motor. Further, the linear actuator 20 is described as actuating a valve one, but it is understood that the linear actuator could operate another element, e.g. control rod of a molten salt nuclear reactor.

In a typical molten salt nuclear reactor 40 setting as shown in FIG. 8, there are multiple pumps 10. Each pump 10 is connected to a heat exchanger 42 and/or a coolant loop 44 or 45 for cooling the reactor core 41 or to the reactor core 41 by a fuel salt loop 43. The fuel salt loop 43 provides fuel salt for driving and controlling the nuclear reaction in the nuclear reactor core 41; further, the heat exchangers 42 provide the primary and secondary reactor coolants via the reactor coolant loop 44 and the secondary coolant loop 45. The pumps 10 circulate and drive the flow of molten salt/molten fuel salt. The valves 1 are used to open and close the loops as circumstances require. The valves 1, can also be arranged differently in the system, for example, to allow working fluids to be added or removed to a salt loop transferring or circulating molten salt in a molten salt pyroprocessing systems. The valve can also be used in molten salt concentrated solar power systems, thermal molten salt storage, and molten salt pyroprocessing systems, and a transfer line or pyroprocessing system might not be pumping or moving the salt in a loop, but just transferring in or out.

The valve 1 comprises a valve body 3 that defines an inlet 4, an outlet 5, and valve seat 17 arranged between the inlet 4 and the outlet 5. A linearly movable tubular valve member 7 cooperates with the valve seat 7 to allow the valve 1 to have a closed and a range of open positions, allowing the valve to be used to control the amount of throttling that is applied to the flow through the valve. The valve 1 is configured for operation at elevated temperatures, for example above 450° C. or above 500° C. or above 550° C.

In the present embodiment, the valve body 3 has an opening that allows the linearly movable tubular valve member 7 to protrude out of the valve body 3, and into the linear motor 20. The linear movable valve member 7 is guided to allow a sliding translator movement relative to the valve body 3.

One end of the linearly movable valve member 7 is in sealing contact with the valve seat 17 when the linearly movable valve member 7 is in the closed position shown in FIG. 3. In this closed position there is a circular contact line or area between the linear movable valve member 7 and the valve seat 17.

The linearly movable valve member 7 has a lumen, which is in fluidic communication with the inlet 4 in all positions of the linearly movable valve member 7, i.e. also in the closed position. Due to the lumen always being in fluidic communication with the inlet 4, a pressure differential between the fluid in inlet 4 and the fluid in outlet 5 will not cause any force on the linear movable valve member 7, since the end of the linear movable valve member 7 opposite to the end that engages the valve seat 17 is surrounded by fluid with the same pressure as in the inlet 4. When the linearly movable valve member 7 has lift, i.e. when the movable valve member 7 is in an open position, as shown in FIG. 2, there is a fluidic connection between the inlet 4 and the outlet 5, creating an opening that allows for a flow of fluid from the inlet 4 to the outlet 5. The opening can be relatively large so as to achieve an opening that has a cross-sectional area that is comparable to that of the inlet 4 and outlet 5. The linearly movable valve member 7 has a range of open positions valve 1, controlled by the linear motor 20, which is configured to move and position the linearly movable valve member 7 to the closed position or any of the open positions. The linearly movable valve member 7 is preferably supported by a first- and second plain bearings 15, 16. In the present embodiment, the first plain bearing 15 is a ring of graphite, silicon carbide ceramic, or ceramic composite material of carbon, silicon carbide or a combination of the two, that is received in a corresponding recess in the valve body 3.

The linear movable valve member 7 is configured for use with molten salt, such as molten salt used in a molten salt nuclear reactor, the molten salt having temperatures between 40° and 700° C. The molten salt may comprise a fluoride, chloride salt with or without fissile or fertile material, such as thorium, uranium, and/or plutonium, or a nitrate salt without fissile or fertile material. The valve body 3 and the linearly movable valve member 7 are preferably made from a temperature and corrosion-resistant material, such as in iron or nickel alloys examples of which are stainless steel and Inconel. In an embodiment, the metal shaft of the movable valve member 7, is coated or treated to harden the metal surface for improving wear assistance in the plain bearing 15, 16. The valve body 3 is preferably manufactured by casting followed by machining.

The tubular translational mover 8 is at least partially received inside the lumen of the stator 11 and is coupled to the linearly movable tubular valve member 7 to move in unison therewith. The mover 8 is made of iron or other suitable material. The mover 8 has in this embodiment a plurality of circumferential projections 9. The stator 11 comprising at least two stator windings surrounding the lumen and a portion of the mover 8 that is received inside the lumen for inducing a magnetic field that penetrates the mover 8. A can 18, particularly a containment shell, separates a working fluid area (molten salt) from a dry area containing the stator 11, with the mover (8) arranged in the working fluid area. The shell 18 is at least partially formed by a thin-walled pipe made of stainless steel or a high nickel steel alloy such as Hastelloy-N.

The stator 11 is received in a housing 2. Electrical terminals 21,22 extend from the inner side of the housing 2 through the openings in the housing 2 to the outer side of the housing 2. The openings are provided with an electrical insulator 24, preferably a ceramic insulator 24, or other insulator 24 that is suitable for operation in a high-temperature environment.

The working fluid is in an embodiment allowed to flow through a clearance. The clearance is fluidically connected to the lumen of the mover 8, thereby allowing for a bypass flow of working fluid from the inlet 4 to the clearance and from the clearance to the outlet 5. This relatively small flow of working fluid serves to cool the linear motor 20, which would otherwise become hotter than the working fluid due to the electric current used to power the linear motor 20. The pressure difference between the inlet for the outlet 5 forces a bypass flow of working fluid through the clearance. The resulting flow of working fluid through the clearance 20 and the lumen absorbs heat (cools the linear motor 20) and transports heat away from the linear motor 20. Simultaneously, the working fluid lubricates the first- and second plain (slide) bearings 15, 16. The connection between the clearance between the hollow mover 8 and the inlet 4 and the outlet 5 allows for a continuous flow of the working fluid which results in an uninterrupted cooling of the linear motor 20 as well as the uninterrupted lubrication of the first- and second plain bearings 15, 16.

The tubular switched reluctance linear motor 20 comprises a mover 8 formed by a hollow, mobile ferromagnetic cylinder with alternating (regularly spaced) circumferential slots and circumferential teeth (projections) 9 and an outer cylindrical stator 11 containing a number of identical phase sets and provided with a lumen in which the mover 8 is at least partially received. Each phase set comprises a magnetic core, formed by two ferromagnetic rings 26,27 and an enclosed stator winding 12. The first- and second ferromagnetic rings are in an embodiment iron or cobalt alloy rings 26,27.

Each phase set of first- and second ferromagnetic rings 26, 27 of the stator 11 is separated from a neighboring phase set by a non-magnetic ring 25. The coils (windings) are sequentially excited in order to create a magnetic field moving from one end to the other.

The structure is simple and robust, and the mover 8 has no windings. The linearly movable valve member 7 is fixed inside the cylindrical mover 8.

Each stator phase comprises an electrically conductive solid bar 12, preferably a copper bar 12. At least a portion of the length of the electrically conductive solid bar 12 is arranged spirally. The spirally arranged portion of the length of electrically conductive solid bar 12 is arranged between the first- and second ferromagnetic rings 26,27.

The spirally arranged portion of the length of electrically conductive solid bar 12 is positioned (secured) between the first- and second ferromagnetic rings 26,27, by one or more spacers 13, preferably ceramic spacers 13, for electrically insulating the electrically conductive solid bar 12 from the first- and second ferromagnetic rings 26,27.

The stator windings 12 are spaced to match the spacing between the circumferential projections 9, the spacing between the stator windings 12 and the circumferential projections 9 preferably being a regular spacing.

The stator windings 12 together with the first- and second ferromagnetic rings 25, 26 are arranged in a stack to form phases, preferably with a nonmagnetic ring 25 separating neighboring first- and second ferromagnetic ring 26,27 of two consecutive stator windings 12 in the stack 11.

The second ferromagnetic ring 27 is provided with an annular recess 37 in which at least a portion of the spirally arranged portion of the length of electrically conductive solid bar 12 is received. Preferably, this recess has a height (extent in the axial direction) that is slightly larger than the thickness of the spirally arranged portion of the links of the electrically conductive solid bar 12.

A radially extending straight electrically conductive bar 19, protrudes substantially radially from the stator (11) to form an electric terminal. The electrically conductive bar 19 is connected to the inner end of the spiral section of the conductive bar 12, for example by brazing. The electrically conductive bar 19 is received in a first radially extending channel 38 in the second ferromagnetic ring 27, to allow the electrically conductive bar 19 to protrude from the stator and through the housing 2. Spacers 13 position and electrically insulate the electrically conductive bar 19 in the first radially extending channel 38.

A radially arranged section 21 of the electrically conductive bar 12 extends radially from the stator 11 and through the housing 2 to form an electric terminal 21. The radially arranged section 21 is received in a second radially extending channel 39 in the second ferromagnetic ring 27. Spacers 13 position and electrically insulate the radially arranged section 21 in the second radially extending channel 39.

Neither iron nor copper is chemically compatible with molten fluoride and chloride salts, and since the molten salts are electrically conductive, iron and copper would also suffer galvanic corrosion and electrolysis due to the applied voltage. Hence, the stator 11 has been mechanically isolated from the working fluid (molten salt). Hereto, a can 18, particularly a containment shell, separates the working fluid area, from the dry area containing the stator 11, with the mover 8 arranged in the fluid area.

Stainless steel 316L has good corrosion resistance to salt, is relatively inexpensive, readily available, and hence most of the linear motor 20 is made from 316L, including a thin-walled can 18 that separates the stator 11 from the working fluid (molten salt). The stator 11 is positioned in the dry area as the (copper) stator windings 12 must be mechanically isolated from the working fluid area as the stator windings 12 may suffer from galvanic corrosion and electrolysis due to the applied voltage in a molten salt e.g. molten fluoride or chloride salt environment.

The stator windings 12, made of solid stator bars 12, preferably of solid copper bars 12 which generate a magnetic field that penetrates the mover 8 causing the mover 8 to linearly move. The solid stator bars 12 are preferably made of copper or of a copper alloy since such materials are good electrical conductors and retain their electrical properties at operating temperatures of up to 800° C.

The solid stator bars 12 are in the present embodiment not enveloped in any form of electric insulation material (except for being at least partially enveloped in the spacers 13).

The spacers 13 position, hold, and space the solid bars 12 in their designated places apart from each other between the respective first- and second ferromagnetic rings 26,27, allowing the solid bars 12 to only be in physical contact with the spacers 13, and the terminals 21,22. The spacers 13 are either electrically insulating or have a high electric resistance (low electric conductivity). The spacers 13 are in an embodiment made of non-electrically conducting ceramic material (e.g. aluminum oxide (alumina) or silicon carbide (SiC)). In an embodiment, the spacers 13 are made from Quartz based materials, such as glass. In an embodiment, the spacers 13 comprise braided quartz fiber material. Other suitable materials for the spacers 13 are semiconductors, such as Germanium, Silicon, Gallium, Arsenide, Gallium Phosphide, and Cadmium Sulfide. In an embodiment, the spacers 13 are formed by refractory cement, the refractory cement having been applied after positioning the solid bars 12 between the first and second ferromagnetic rings 26 and 27. In an embodiment the solid bars 12 are positioned between the first- and second ferromagnetic rings 26,27 by being embedded in an electrically insulating material, the insulating material preferably being refractory cement.

The spacers 13 allow the stator bars 12 to be positioned between and electrically insulated from the first- and second ferromagnetic rings 26,27. A pair of spacers 13 is formed by an “upper” spacer 13 that is arranged between the stator bar 12 and the first ferromagnetic ring 26 and a “lower” spacer 13 that is arranged between the stator bar 12 and the second ferromagnetic ring 27.

The spacers 13 may also be formed from refractory cement, which may be applied before or after positioning the solid bars 12 in the slots 11. There may be two or more spacers 13 in two or more circumferential spaced positions along the circumferential extent of the solid bars 12 between the first- and second ferromagnetic rings 26,27, e.g. FIG. 7 shows the use of five pairs of spacers 13, each pair spacers 13 circumferentially spaced position along the length of the solid bar 12. Preferably, the spacers 13 do not completely envelop the solid bars 12.

The spacers 13 are formed like clips with a plurality of grooves, with the grooves matching the spacing and number of windings of the spiral part of the solid bars 12, so that the windings are kept distanced from one another and electrically insulated from one another.

In an embodiment, the first and second ferromagnetic rings 26, 27 are provided with a number of circumferentially distributed radially extending recesses 14, in which a portion of the spacers 13 is received for securing the spacer relative to the respective ferromagnetic ring 26, 27.

Due to the fact that the solid bars 12 are relatively stiff, there will be no physical contact between neighboring windings of solid bars 12 and no contact between solid bars 12 and the walls of the first and second ferromagnetic rings 26, 27, even when force is applied to the solid bars 12 by the magnetic field of the linear motor 20.

The stator bars 12 are preferably made from copper or other highly conductive materials with suitably high melting points and strength required for use in molten salt reactors or other, high temperature applications, such as W or Cu—Ni alloys. The electrical connections to the solid bars 12 are in an embodiment brazed, e.g. brazed with Cu—Ag eutectic metal brazing compounds which have lower melting points than Cu, but Ag does not introduce impurities that affect the conductivity of the stator bars 12, unlike most other metals that may be used for brazing.

In the shown embodiment the solid bars 12 have a substantially square cross-sectional shape, with rounded edges. However, it is understood that the solid bars 12 could have other suitable cross-sectional shapes, such as a polygon cross-sectional shape, a rectangular cross-sectional shape, or a circular or oval, or rounded cross-sectional shape. The rectangular cross-section allows for a high ratio of the cross-sectional area of the solid bars 12 in the stator 11, thereby increasing the conductivity of the stator windings, increasing fill factor, and improving motor power and efficiency.

The solid bars 12 may, at least for their spiral extent, be a prismatic solid bar 12, i.e. the cross-sectional shape of the bar is the same all along its length.

In an embodiment, the electrically conductive solid bar 12 has a uniform cross-section throughout the spirally arranged portion of length electrically conductive solid bar 12.

The cross-sectional area of the solid bars 12 is in an embodiment at least 16 mm2, preferably at least 13 mm2, more preferably at least 10 mm2, even more preferably at least 7 mm2, most preferably at least 5 mm2.

A certain cross-sectional area and shape are required for providing sufficient rigidity for the solid bars 12, such that the solid bars 12 do not touch each other or touch the walls of space in which they received, even when they bend on the influence of the magnetic fields generated during operation of the linear motor 20. By using solid bars 12 instead of e.g. wires for the stator windings, the solid bars 12 have sufficient rigidity to maintain their shape sufficiently under the influence of the magnetic forces generated when the linear motor 20 is operated to ensure that there is no contact between neighboring solid bars 12 and between solid bars 12 and the ferromagnetic rings 26,27 between which they are received, even though the solid bars 12 are supported only locally and distanced by spacers 13. The solid bars 12 are only supported between the first and second ferromagnetic rings 26, 27 by the spacers 13. Preferably the solid stator bars 12 are substantially prismatic (uniform cross-section) over the full length of the solid stator bars 12 in a slot 11 and protrude from both axial ends of the slot 11.

The end of the stator bar 12 that protrudes from the stator 11 can either be straight or bend, according to need and form an electric terminal 21 for connection to a controllable power amplifier. A controller is configured to individually or pairwise control current through the respective windings 12, preferably current delivered by power amplifiers, for energizing the respective windings 12 and controlling the position and movement of the mover 8. In an embodiment, there are three pairs of coils that can be energized separately. Three pairs of thee coils each, making up a stack of nine coils. To move the mover 8 up or down the three pairs are sequentially turned on and off independently, achieving the function of linear motion.

In an embodiment, the linear motor 20 and valve 1 are constructed to operate at temperatures above 450° C., preferably above 500° C. even more preferable above 550° C.

The stator 11 comprises a plurality of independently or pairwise operated actuating coils (windings). The respective coils generate a magnetic field when current is supplied, which magnetizes the (ferromagnetic) mover 8 and the activated stator coil and creates a magnetically attractive circumferential force between the activated stator coil and a respective circumferential projection 9 of the mover 8.

The respective stator bars 12 are connected to power amplifiers that supply current to the stator bars 12.

In an embodiment, the power amplifiers are solid state devices that operate in a pulse width modulation configuration. The controller is in an embodiment a microprocessor or digital signal processor.

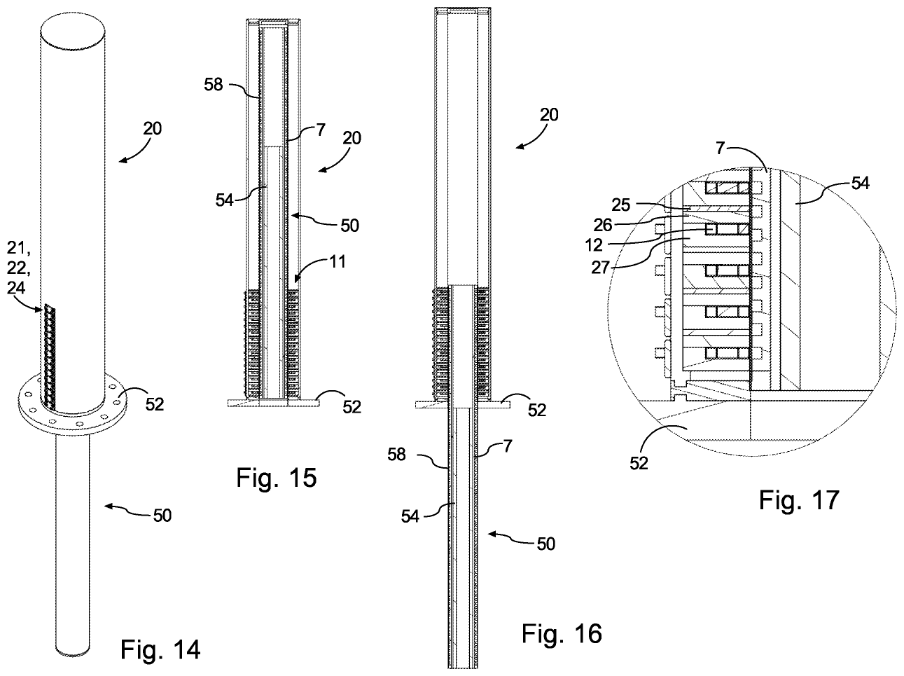

The same or similar construction as explained above can be used for linear motor actuating a control rod 50 of a nuclear reactor, as shown in the embodiment of FIGS. 14 to 17. FIG. 15 shows the control rod 50 in its completely retracted position and FIG. 16 shows the controller 50 in a completely extended position. The control rod 50 will, under the action of the tube the linear motor 20, be able to assume any position between these extremes. In this embodiment, structures and features that are the same or similar to corresponding structures and features previously described or shown herein are denoted by the same reference numeral as previously used for simplicity. In this embodiment, the actuator 20 and the tubular mover 7 is the same as in the embodiment above and below, with the tubular mover 7 having iron teeth (circumferential teeth (projections)), and the linear tubular motor 20 being a switched reluctance or AC induction linear motor. The tubular the mover 7 can be contained in a thin-walled can 58, to protect the tubular mover 7 from the molten salt in the nuclear reactor core. The thin-walled can 58 be made of stainless steel or a high nickel steel alloy such as Hastelloy-N. In the shown embodiment the linear tubular motor 20 comprises four pairs of four coils for the stator 11. There is an additional rod 54 of neutron absorbing material arranged on the inner side of the tubular mover 7. The additional rod 54 could be any suitable neutron absorbing material. If the neutron absorber material is not corrosion resistant to the molten salt, then it should be clad in a suitable material such as stainless steel, same as the rest of the mover.

The action of moving the mover up under the influence of the linear motor 20 and down will submerge the control rod 50b to a greater or lesser extent into the nuclear reactor core and the mover 7 can be in a protective sleeve or submerged directly into the molten salt in the nuclear reactor core.

A flange 52 at the bottom of the linear motor 20 serves to attach to the nuclear reactor core structure.

Slide bearings have not been shown in this embodiment, since the elongated cans 18, 58 on the inner side of the stator and on the other side of the mover 7, respectively, act as a slide bearing. However, dedicated slide bearings could be used, as shown for the other embodiments.

In an embodiment (not shown), wherein the solid bars 12 have a longitudinal lumen for allowing a cooling medium to flow through the bars 12. This cooling medium is a dedicated cooling medium used to provide additional active/forced cooling to the solid stator bars 12. This embodiment is particularly useful for large linear motors.

In an embodiment (not shown) wherein the solid bars 12 are formed by multiple longitudinally extending filaments or strips, preferably copper filaments or strips, bonded together, for example, the filaments or strips being bonded together by brazing with a low conductivity alloy or bonded by ceramic coating. This embodiment is particularly useful for large linear motors.

In an embodiment (not shown) wherein the mover 8, or the shaft 7 thereof, is supported by radial electromagnetic bearings, preferably active radial electromagnetic bearings. In this embodiment no plain bearings 15, 16 are required.

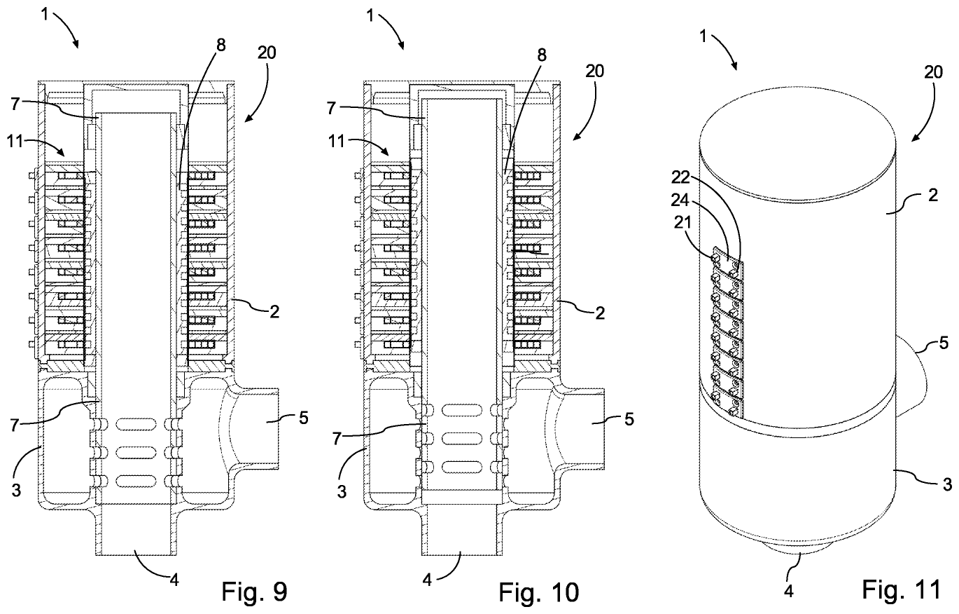

FIGS. 9 to 11 show another embodiment of the linear motor 20, in combination with a valve In this embodiment, structures and features that are the same or similar to corresponding structures and features previously described or shown herein are denoted by the same reference numeral as previously used for simplicity. In this embodiment, the actuator 20 is essentially identical to the embodiment of FIGS. 1 to 8. However, the valve part is different in that it operates on the principle of overlapping openings. Hereto, the valve member 7 is been provided with one or more openings in the part of the mover that extends into the valve body 3. The openings in the valve member 7 are preferably substantially identical in shape and size to corresponding openings in the valve body 3. By moving the valve member 7 linearly, a larger or smaller overlap between the openings in the valve member 7 and the valve body 3, respectively is created, thereby controlling the flow from the inlet 4 to the outlet 5. Thus, this embodiment does not have a valve seat but has instead a valve sleeve, and the movable valve member 7 cooperates with the static valve sleeve.

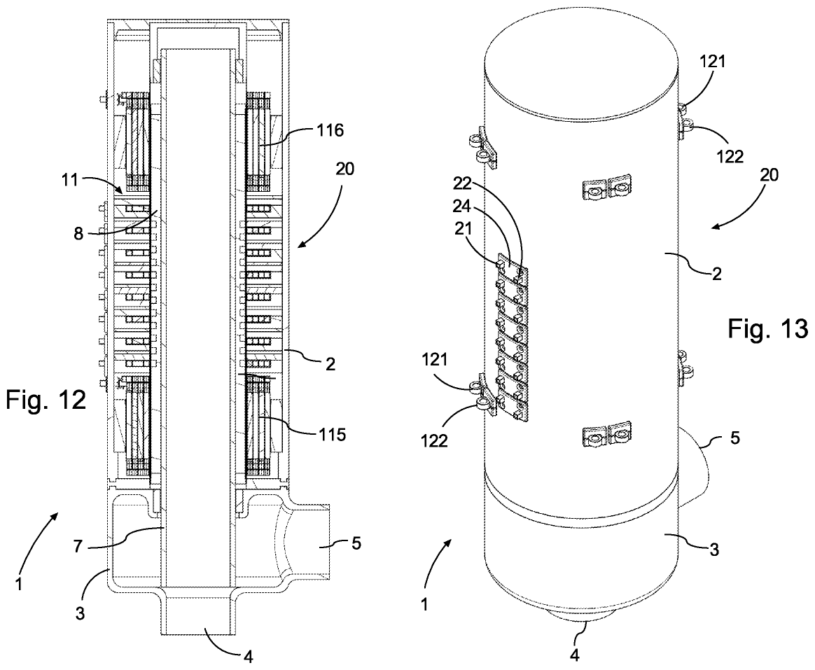

FIGS. 12 and 13 show another embodiment of the linear motor 20, in combination with a valve In this embodiment, structures and features that are the same or similar to corresponding structures and features previously described or shown herein are denoted by the same reference numeral as previously used for simplicity. In this embodiment, the actuator 20 is essentially identical to the embodiment of FIGS. 1 to 8, and the valve part is also essentially identical to the embodiment of FIGS. 1 to 8. However, the plain bearings 15,16 of the embodiment of FIGS. 1 to 8 have been replaced by active electromagnetic bearings 115,116. Electric terminals 121 and 122 serve to connect the coils (windings) of the active electromagnet bearings to a suitable driver.

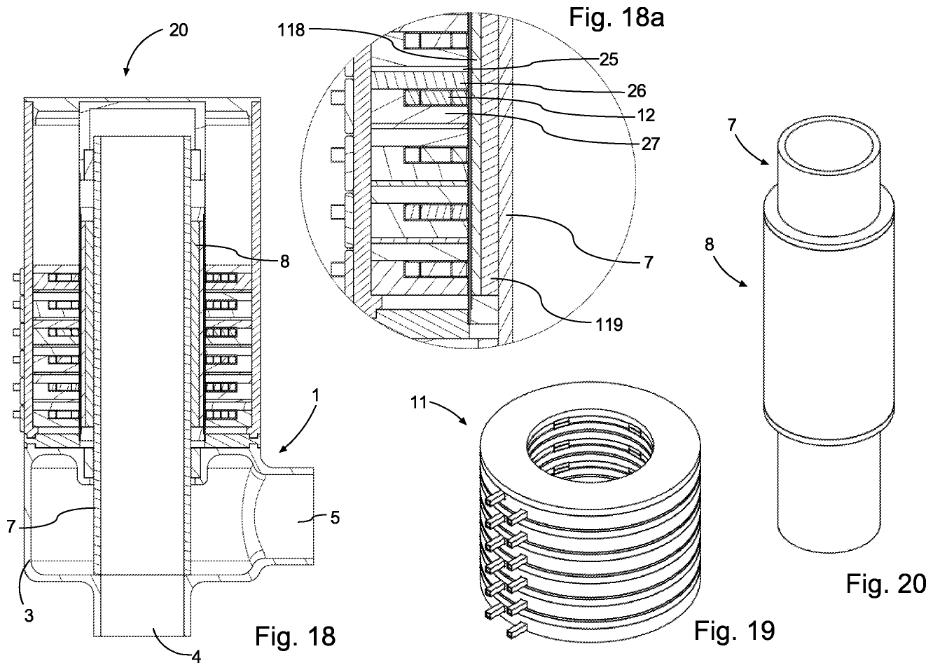

In the embodiment of FIGS. 18 to 20 the mover 8 is an AC induction driven mover. in this embodiment, the coils in stator 11 are the same as in the embodiment before, but the switch reluctance actuator of the embodiment above has four pairs of coils (windings) whilst the present embodiment above has only three pairs of coils (windings). Further, the mover 8 of this embodiment does not have any projections.

The three pairs of coils are actuated with a VFD (variable frequency driver) that creates a moving electromagnetic field that induced a force in the mover 8. The direction of the force caused by the electromagnetic field on the mover 8 is in the same direction as the electromagnetic field is moving, and the mover 8 can thus be urged to move up and down, and held in place if the AC induction force is balanced with the weight of mover 8 and the other forces acting on it. This embodiment is best suited to an either open or closed valve 1, since the VFD can just be set to actuate continuously to keep it open or closed. The mover 8 is made of a can to protect against salt, with an outer copper conductor 118 with an inner iron core 119 to concentrate the magnetic field lines through the copper. However, the linear actuator 20 according to this and other embodiments is not limited to use for actuating a valve, it should be clear that any other device, e.g. a control or a probe, that requires linear movement can be actuated with the linear actuator.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure. As used in the description, the terms “horizontal”, “vertical”, “left”, “right”, “up” and “down”, as well as adjectival and adverbial derivatives thereof, simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

1. A tubular linear motor (20), preferably a switched reluctance or AC induction linear motor, for actuating a component in a molten salt loop (43,44,45), preferably a molten salt loop (43,44,45) in a nuclear reactor (40), the tubular linear motor (20) comprising:
a stator (11) having a lumen,
a tubular translational mover (8) at least partially received inside the lumen,
the stator (11) comprising at least two stator windings, each stator winding surrounding the lumen and a portion of the mover (8) that is received inside the lumen for inducing a magnetic field that penetrates the mover (8),
first- and second ferromagnetic rings (26,27), said first- and second ferromagnetic rings preferably being iron or cobalt alloy rings (26,27),
characterized by
the at least two stator windings each comprising an electrically conductive solid bar (12), preferably a copper bar (12), at least a portion of the length of the electrically conductive solid bar (12) being arranged spirally,
one or more spacers (13), preferably ceramic spacers (13),
at least the spirally arranged portion of the length of electrically conductive solid bar (12) being arranged between the first- and second ferromagnetic rings (26,27), and
the spirally arranged portion of the length of electrically conductive solid bar (12) being positioned between the first- and second ferromagnetic rings (26,27) by the one or more spacers (13) for electrically insulating the electrically conductive solid bar (12) from the first- and second ferromagnetic rings (26,27).

2. The linear motor (20) according to claim 1, wherein the mover (8) is provided with a plurality of circumferential projections and the stator windings (12) are spaced to match the spacing between the projections (9).

3. The linear motor (20) according to claim 1, comprising a non-magnetic ring (25) placed between a neighboring first- and second ferromagnetic ring (26,27) of two consecutive stator windings (12).

4. The linear motor (20) according to claim 1, wherein the stator windings (12) together with the first- and second ferromagnetic rings (26, 27) are arranged in a stack, with a nonmagnetic ring (25) separating neighboring first- and second ferromagnetic ring (26,27) of two consecutive stator windings (12) in the stack.

5. The linear motor (20) according to claim 1, wherein, the electrically conductive solid bar (12) has a uniform cross-section throughout the spirally arranged portion of length electrically conductive solid bar (12).

6. The linear motor (20) according to claim 1, wherein the one or more spacers (13) are provided between the spirally arranged portion of the length of an electrically conductive solid bar (12) and the first ferromagnetic ring (25) and the spirally arranged portion of the length of electrically conductive solid bar (12), and wherein the one or more spacers (13) are provided between the spirally arranged portion of the length of the electrically conductive solid bar (12) concerned and the second ferromagnetic ring (27).

7. The linear motor (20) according to claim 1, wherein the second ferromagnetic ring (27) is provided with an annular recess (37) in which at least a portion of the spirally arranged portion of the length of electrically conductive solid bar (12) is received.

8. The linear motor (20) according to claim 1, wherein the first- and/or second ferromagnetic rings (26,27) are provided with one or more spacer recesses (14) for receiving and securing at least a portion of the spacers (13).

9. The linear motor (20) according to claim 8, wherein the first- and/or second ferromagnetic rings (26,27) are provided with a plurality of circumferentially spaced spacer recesses (14).

10. The linear motor (20) according to claim 1, wherein the stator winding (12) comprises a spirally arranged electrically conductive bar, electrically coupled to a radially extending straight electrically conductive bar (22), that protrudes radially from the stator (11) to form an electric terminal.

11. The linear motor (20) according to claim 1, wherein the stator winding (12) comprises an electrically conductive bar (12) that comprises a spirally arranged section and a radially arranged section (21).

12. The linear motor (20) according to claim 1, comprising a controller configured to control current through the respective windings (12), for controlling the position and movement of the mover (8).

13. The linear motor (20) according to claim 1, wherein the spacers (13) are electrically insulating or have low electric conductivity.

14. The linear motor (20) according to claim 1, wherein the spacers (13) are configured to space the solid bar (12) from surfaces of the first- and second ferromagnetic rings (26,27), and/or configured to space turns of the spirally arranged portion of the length of electrically conductive solid bar (12) from one another.

15. The linear motor (20) according to claim 1, wherein the mover (8) is supported by radial electromagnetic bearings.

16. An assembly of a valve (1) for controlling a flow of molten salt and the linear motor (20) according to claim 1, said valve (1) comprising a movable valve member (7) operably coupled to said mover (8) of the linear motor.

17. An assembly of a control rod (50) for controlling a nuclear reactor and the linear motor (20) according to claim 1, wherein said control rod is (50) operably coupled to said mover (8) of the linear motor.

18-20. (canceled)

21. The linear motor (20) according to claim 1, wherein the linear motor (1) is a switched reluctance or AC induction linear motor.

22. The linear motor (20) according to claim 1, comprising a control rod, wherein said control rod is (50) operably coupled to said mover (8) of the linear motor.
